(19) United States
(12) Patent Application Publication
(10) Pub. No.: US 2024/0199983 A1
(43) Pub. Date: Jun. 20, 2024

(54) FABRIC SERUM COMPOSITION

(71) Applicant: Conopco, Inc., d/b/a UNILEVER, Englewood Cliffs, NJ (US)

(72) Inventors: Amanda Jane ADAMS, Wallasey (GB); Karl BURGESS, Prenton, Wirral (GB); Alastair Richard SANDERSON, Ellesmere Port (GB); Iain Murdoch STEVENSON, Bracknell (GB)

(73) Assignee: Conopco, Inc., d/b/a UNILEVER, Englewood Cliffs, NJ (US)

(21) Appl. No.: 18/286,157

(22) PCT Filed: Apr. 14, 2022
(86) PCT No.: PCT/EP2022/060027

§ 371 Date: Oct. 9, 2023

(30) Foreign Application Priority Data
Apr. 15, 2021 (EP) 21168521.9

(51) Int. Cl. C11D 1/825; C11D 1/72; C11D 3/22; C11D 3/50

(52) U.S. Cl. CPC C11D 1/825; C11D 3/222; C11D 3/50; C11D 1/72

(57) ABSTRACT

A laundry serum composition comprising: a) ingredient comprising at least one ethoxylate unit and at least one carbon derived from carbon capture; b) free perfume; and c) 0 to 4 wt. % anionic and/or cationic surfactant.

### FIELD OF THE INVENTION

The present invention relates to fabric serums comprising carbon from carbon capture.

### BACKGROUND OF THE INVENTION

The consumer preference for ancillary laundry products is growing. Consumers increasingly are looking for laundry products to use in addition to their laundry detergent and fabric conditioner to provide additional or alternate benefits to their fabrics. Such products allow the consumer to tailor their laundry process to suit their needs and preferences. One type of product are so called ‘laundry serums’.

WO 2020/035277 discloses a laundry serum composition comprising non-ionic surfactant benefit agents and water.

Fabric serums may comprise ingredients comprising ethoxylate groups, such as alcohol ethoxylates and polyethylene glycol ingredients.

Fragrance performance is an essential feature for laundry serums. Many consumers judge the efficacy of the product based on perfume performance. Perfume performance may be judged on the product in the bottle, on wet fabrics, while drying, on dry fabrics, when folding and putting away, when wearing, or any combination of these touch points. Fragrance performance may be judged by quantity of fragrance, longevity or quality.

Stability is also an important feature of laundry serums. Instability is indicated by separation, increased or decreased viscosity, a change in the fragrance, flocculation of microcapsules or a change in the aesthetics, such as a colour change.

Finally, the aesthetics of the laundry serums are important, since the compositions tend to be clear. Aesthetics and stability are very closely linked; poor aesthetics can indicate poor stability. Equally aesthetics can be linked to the fragrance composition within a product. There is a need to further improve laundry serum fragrance performance, aesthetics and/or stability.

In addition to the need for improved laundry serums, there is a growing need to address climate change, in particular greenhouse gases. There is a need to slow the rate at which carbon containing gases enter the atmosphere. In light of this, some consumers prefer so called ‘eco-friendly’ products which have a reduced impact on the environment. However often consumers associate ‘eco-friendly’ products reduced efficacy. Equally consumers can find it difficult to understand in tangible terms, the positive impact a product may have on the environment.

In view of the above, there remains a need for laundry serum compositions with a good environmental profile without compromising consumer satisfaction in terms of fragrance, stability and/or aesthetic performance.

### SUMMARY OF THE INVENTION

We have found that the laundry serum compositions described herein, comprising an ingredient comprising at least one ethoxylate unit and at least one carbon derived from carbon capture, provide an improved environmental profile while maintaining or improving consumer satisfaction. In particular, a difference in fragrance profile is provided when an ingredient comprising at least one ethoxylate unit and at least one carbon derived from carbon capture are included in a laundry serum composition. The difference in fragrance profile allows the consumer to identify a more environmentally friendly product and allows the producer the simplicity of continuing to use the same fragrance, but achieving a different fragrance profile. Viscosity may also be improved leading to a lower product viscosity. Without wishing to be bound by theory it is believed that improvements in the laundry serums are a consequence of the ingredients comprising carbon atoms from carbon capture.

In one aspect of the present invention is provided a laundry serum composition comprising:
a) ingredient comprising at least one ethoxylate unit and at least one carbon derived from carbon capture;
b) Free perfume;
c) 0 to 4 wt. % anionic and/or cationic surfactant.

The invention further relates to a method of preparing a laundry serum composition, wherein the method comprises the steps of:
i. Obtaining an ingredient comprising at least one ethoxylate unit and at least one carbon derived from carbon capture;
ii. Incorporating said ingredient into a laundry serum composition.

The invention additionally relates to a use of a laundry serum as described herein to reduce carbon emissions into the atmosphere.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

A laundry serum composition in the context of the present invention is a laundry composition intended for use in addition to a traditional detergent or fabric conditioner formulation. The laundry serum composition provides an additional benefit over and above those delivered by a detergent or fabric conditioner and they provide the consumer with the ability to customise the levels of benefit agents delivered in the wash. The laundry serum is a liquid and may be added either in the wash or the rinse.

The term ‘virgin fossil fuels’ refers to fossil fuel sources (coal, crude oil, natural gas) which have not been used for any other purpose, i.e. has not been burnt for energy, or is not the waste gas from an industrial process.

The term ‘biomass’ refers to organic mass derived from plant materials and/or microorganisms (such as algae/microalgae/fungi/bacteria). Biomass includes, plant materials, agricultural residues/waste, forestry residues/waste, municipal waste provided this excludes fossil , yard waste, manufacturing waste, landfill waste, sewage sludge, paper and pulp etc. and the like.

The compositions described herein comprise ingredients comprising at least one ethoxylate unit and at least one carbon derived from carbon capture. To obtain these ingredients from carbon capture, carbon must be captured, separated (where required) and utilised or transformed into an ingredient for use in a laundry serum. The capture, separation and transformation may happen in one continuous process or may be separate steps which may be carried out at different locations.

### Carbon Capture and Separation

Carbon capture refers to the capture or sequestration of C1 carbon molecules (e.g. carbon monoxide, carbon dioxide, methane or methanol). By capturing the carbon molecules, they are removed from or prevented from entering the environment. Carbon sourced from carbon capture contrasts with carbon from virgin fossil fuels (crude oil, natural gas, etc.), in that captured carbon has already been used at least once; for example captured carbon may have been burned to produce energy and is captured to enable a second use of the carbon, whereas carbon from virgin fossil fuels have been extracted for that singular purpose. Captured carbon may equally be obtained from non-fossil fuel carbon emitters, such as biomass energy plants, brewery gases from fermentation (e.g. of wheat), burning of biomass fuels (e.g. vegetable oil, biogas or bio-ethanol). By capturing and utilising carbon, carbon can be used again, leading to less carbon in the atmosphere and reduced use of virgin fossil fuels. In other words by capturing carbon either already in the atmosphere or before it enters the atmosphere, the nett reliance on virgin fossil fuels to produce homecare products is reduced. The carbon captured may be in any physical state, preferably as a gas.

C1 carbon capture can be used to help reduce/prevent net release of CO₂ in the environment and thereby forms a valuable tool to address climate change. When the C1 carbons captured are derived from combusted fossil sources then the immediate CO₂ released can be reduced. When C1 carbons are derived directly from the atmosphere or from bio-sources there may even be a net immediate reduction in atmospheric CO₂

Carbon capture may be point source carbon capture or direct carbon capture. Direct carbon capture refers to capturing carbon from the air, where it is significantly diluted with other atmospheric gases. Point source carbon capture refers to the capture of carbon at the point of release into the atmosphere. Point source carbon capture may be implemented for example at steal works, fossil fuel or biomass energy plants, ammonia manufacturing facilities, cement factories, etc. These are examples of stationary point source carbon capture. Alternatively, the point source carbon capture may be mobile, for example attached to a vehicle and capturing the carbon in the exhaust gases. Point source carbon capture may be preferable due to the efficiency of capturing the carbon in a high concentration. Preferably, the carbon is captured from a point source. More preferably the carbon is captured from a fossil fuel based point source, i.e. carbon captured from an industry utilising fossil fuels.

There are various methods of capturing carbon from industrial processes, examples include:
Capturing carbon from flue gasses following combustion. This may be referred to as post combustion carbon capture. For example, this may be implemented to capture carbon from the flue gasses at a fossil fuel power plant.
Capturing carbon pre-combustion. In these processes, fossil fuels are partially oxidized. Syngas comprising carbon monoxide, hydrogen and some carbon dioxide is produced. The carbon monoxide is reacted with water (steam) to produce carbon dioxide and hydrogen. The carbon dioxide can be separated, and the hydrogen used as fuel.
Oxy-fuel combustion, in which fuel is burned in oxygen rather than air. The flue gas consists mainly of carbon dioxide and water vapour. The water is separated and the carbon dioxide collected.

Once a source of carbon has been captured, the carbon molecules need to be isolated from the other chemicals with which they may be mixed. For example oxygen, water vapour, nitrogen etc. In some point source processes this step may not be required since a pure source of carbon is captured. Separation may involve biological separation, chemical separation, absorption, adsorption, gas separation membranes, diffusion, rectification or condensation or any combination thereof.

A common method of separation is absorption or carbon scrubbing with amines. Carbon dioxide is absorbed onto a metal-organic framework or through liquid amines, leaving a low carbon gas which can be released into the atmosphere. The carbon dioxide can be removed from the metal-organic framework or liquid amines, for example by using heat or pressure.

C1 carbon molecules sourced from carbon capture and suitably separated from other gases are available from many industrial sources. Suitable suppliers include Ineos.

Capturing carbon directly from the air may for example involve passing air over a solvent which physically or chemically binds the C1 molecules. Solvents include strongly alkaline hydroxides such as potassium or sodium hydroxide. For example, air may be passed over a solution of potassium hydroxide to form a solution of potassium carbonate. The carbonate solution is purified and separated to provide a pure CO₂ gas. This method may also be employed in point source capture. An example of a direct air capture process is that employed by carbon engineering.

### Carbon Utilisation or Transformation

Once the C1 carbon molecules have been capture and separated, they can then be transformed into useful ingredients for use in a laundry serum.

Various methods may be used to transform the captured C1 molecules to useful components. The methods may involve chemical process or biological processes, such as microbial fermentation, preferably gas-fermentation.

Preferably the C1 molecules are transformed into:
i. Short chain (preferably C1-C5) intermediates such as methanol, ethanol, ethylene, ethylene oxide; or
ii. Hydrocarbon intermediates (preferably C6-C20) such as hydrocarbon chains: alkanes, alkenes, etc.

These can be converted further to make the components of surfactants, using well known chemistries e.g. chain growth reactions etc to: longer chain alkenes/olefins, alkanes, longer chain alcohols, aromatics and ethylene, ethylene oxide which is an excellent starter chemical for various ingredients. Preferably the C1 molecules are transformed into short chain intermediates, more preferably ethanol, ethylene or ethylene oxide.

### i. Short Chain Intermediates

One suitable example of transformation is a process in which a reactor converts carbon dioxide, water and electricity to methanol or ethanol and oxygen i.e. electrolysis. An example of this process is provided by Opus 12. Suitable processes are disclosed in WO21252535, WO17192787, WO20132064, WO20146402, WO19144135 and WO20112919.

An alternate suitable example of transformation is the conversion of carbon dioxide to ethanol using a catalyst of copper nanoparticles embedded in carbon spikes.

An alternate suitable example of transformation is the use of biological transformation which involves fermentation of the C₁ carbon by micro-organisms such as C₁-fixing bacteria to useful chemicals. This is alternatively known as gas fermentation, which is defined as the microbial conversion of gaseous substrates (e.g. CO, CO₂, and CH₄) to larger molecules.

The ability of micro-organisms to grow on CO as a sole carbon source was first discovered in 1903. This was later determined to be a property of organisms that use the acetyl coenzyme A (acetyl CoA) biochemical pathway of autotrophic growth (also known as the Woods-Ljungdahl pathway and the carbon monoxide dehydrogenase/acetyl CoA synthase (CODH/ACS) pathway). A large number of anaerobic organisms including carboxydotrophic, photosynthetic, methanogenic and acetogenic organisms have been shown to metabolize CO to various end products, namely CO₂, H₂, methane, n-butanol, acetate and ethanol. Preferably anaerobic bacteria such as those from the genus Clostridium are used to produce ethanol from carbon monoxide, carbon dioxide and hydrogen via the acetyl CoA biochemical pathway. There are a variety of microorganisms that can be used in a fermentation processes, particularly preferred are anaerobic bacteria such as Clostridium ljungdahlii strain PETC or ERI2, which can be used to produce ethanol.

Exemplary gas fermentation processes are, but not limited to, syngas fermentation and aerobic methane fermentation as described (B. Geinitz et. al. Gas Fermentation Expands the Scope of a Process Network for Material Conversion. Chemie Ingenieur Technik. Vol 92, Issue 11, p. 1665-1679.). The microbes with the ability to convert CO and CO₂ fall primarily into the group of anaerobic acetogenic bacteria or aerobic carboxydotrophic bacteria, those able to convert methane are methanotrophs, which are usually aerobic methanothrophic bacteria. In this sense the term ‘gas fermentation’ is used loosely and includes the aerobic or anaerobic microbial or enzymatic conversion of organic matter preferably by syngas fermentation and aerobic methane fermentation.

Gas-fermentation can include multi-stage fermentation, mixed fermentation, co-cultivation, mixotrophy and thermophilic production. Multi-stage fermentation can broaden the portfolio of products obtained together with higher end-product concentrations. Mixed fermentation may help some strains to detoxify the environment from a toxic compound or reduce the concentration of a certain product allowing for a more efficient conversion of the gas or increased product yield (e.g. by a second strain). Mixotrophy is the use of two or more carbon/electron sources simultaneously by some microorganisms, where for example both CO₂ and organic substrates such as sugars are utilized together. Thermophilic production (gas-fermentation at elevated temperatures by thermophilic strains, such as carboxydotrophic thermophiles) offers the advantages of reducing the risk of contamination. The gas-fermentation cultures may be defined or undefined, but preferably are in part or in the whole defined. Use of defined cultures offers the benefit of improved gas-fermentation end-product control.

Preferably the C1 molecules are transformed to short chain intermediates by gas fermentation. More preferably the C1 molecules are transformed to ethanol, ethylene or ethylene oxide by gas fermentation.

### ii. Hydrocarbon Intermediates

One suitable example is the Fischer-Tropsch process. Carbon dioxide and carbon monoxide can be chemically transformed to liquid hydrocarbons by the Fischer-Tropsch process, using hydrogen and a metal catalysis. Carbon dioxide feedstocks must first be converted to carbon monoxide by a reverse water gas shift reaction.

An alternate method for transformation into hydrocarbon intermediates solar photothermochemical alkane reverse combustion reactions. These are a one-step conversion of carbon dioxide and water into oxygen and hydrocarbons using a photothermochemical flow reactor.

Further examples of carbon capture technologies suitable to generate the ethanol stock for use in manufacturing ethoxy sub-units for use in the surfactants described herein are disclosed in WO 2007/117157, WO 2018/175481, WO 2019/157519 and WO 2018/231948.

### Ingredients Comprising an Ethylene Oxide Group

The compositions described herein comprise ingredients comprising at least one ethoxylate unit and at least one carbon derived from carbon capture. Preferably the compositions comprise 0.05 to 10 wt. % ingredients comprising at least one ethoxylate unit and at least one carbon derived from carbon capture, more preferably 0.1 to 5 wt. % and most preferably 0.1 to 4 wt. % ingredients comprising at least one ethoxylate unit and at least one carbon derived from carbon capture by weight of the composition.

The carbon derived from carbon capture may be found anywhere within the chemical structure of the ingredient molecule. Preferably the carbon derived from carbon capture forms part of an alkyl chain or an ethoxylate group, preferably an ethoxylate group. Preferably at least 50 wt. % of the carbon atoms are obtained from carbon capture, more preferably at least 70 wt. % and most preferably all of the carbon atoms are obtained from carbon capture. Preferably, less than 90 wt. %, preferably less than 10 wt. % of the carbon atoms within the ingredient are obtained directly from virgin fossil fuels.

### Carbon Located in Alkyl Chain:

Where the carbon derived from carbon capture is located in an alkyl chain, preferably on average at least 50 wt. % of the carbons in the alkyl chain are derived from carbon capture, more preferably at least 70 wt. %, most preferably all of the carbons in the alkyl chain are derived from carbon capture.

As described above, suitable carbon chains can be obtained from a Fischer-Tropsh reaction. The feedstock for the Fischer-Tropsch may be 100% carbon obtained from carbon capture or may be a mixture of carbon from different sources. For example carbon gases from natural gas could be used, although this is not preferable. Preferably the alkyl chain comprises less than 10 wt. % carbon obtained directly from virgin fossil fuels more preferably the alky chain comprises no carbon obtained directly from virgin fossil fuels.

Alternatively, the alkyl chain may be a combination of alkyl groups from carbon capture and alky groups from triglycerides, preferably triglycerides are obtained from plants, such as palm, rice, rice bran, sunflower, coconut, rapeseed, maze, soy, cottonseed, olive oil, etc.

### Carbon Located in Ethoxylate Group:

Where the carbon derived from carbon capture is located on an ethoxylate group, preferably on average at least 50 wt. % of the ethoxylate carbons in the molecule are derived from carbon capture, more preferably at least 70 wt. %, most preferably all the ethoxylate carbons in the molecule are derived from carbon capture. In a single ethoxylate monomer, one or both carbons may be carbons obtained from carbon capture, preferably both carbons are carbons obtained from carbon capture. Preferably, more than 10 wt. %, preferably more than 90 wt. % of the ethoxylate groups comprise carbon atoms obtained from carbon capture based sources. Alternate sources of carbon include plant based carbon, for example ethanol obtained from the fermentation of sugar and starch (i.e. ‘bio’ ethanol). The ethoxylate groups may comprise carbons from virgin fossil fuels, however this is not preferable. Preferably, less than 90 wt. %, preferably less than 10wt. % of the ethoxylate groups comprise carbon atoms obtained directly from virgin fossil fuels.

To produce ethoxylates from carbon capture, first ethanol produced as outlined above is dehydrated to ethylene. This is a common industrial process. The ethylene is then oxidised to form ethylene oxide.

Depending on the desired material, different routes are available.

If an alcohol ethoxylate is desired, the ethylene oxide can be reacted with a long chain fatty alcohol via a polymerisation type reaction. This process is commonly referred to as ethoxylation and gives rise to alcohol ethoxylates. Preferably the long chain fatty alcohol comprises carbon from carbon capture and/or from a plant source. More preferably the long chain fatty alcohol comprises only carbon from carbon capture and/or from a plant source. Most preferably and fatty alcohol comprises only carbon from carbon capture.

If a polyethylene glycol is desired, the ethylene oxide can be polymerised, for example in the presence of water and a catalyst to yield a polyethylene glycol chain.

Preferably all carbons within the ingredient molecule are derived from a plant source or carbon capture. Most preferably, all carbons are derived from carbon capture.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

Preferably the ingredients comprising at least one ethoxylate unit and at least one carbon derived from carbon capture is selected from alcohol ethoxylates, polyethylene glycols and materials substituted with polyethylene glycols.

### Alcohol Ethoxylates:

Alcohol ethoxylates have the general formula:

R—Y—(C₂H₄O)₂—CH₂—CH₂—OH

Wherein R is an alkyl chain. When the ingredient comprising at least one ethoxylate unit and at least one carbon derived from carbon capture is an alcohol ethoxylate, the carbon obtained from carbon capture may be located in the alky chain or the ethoxylate group. Preferably both the alkyl chain and ethoxylate comprise carbon obtained from carbon capture.

R is preferably 8 to 60, more preferably 10 to 25, even more preferably 12 to 20 and most preferably 16-18.
Y is selected from:
—O—, —C(O)O—, —C(O)N(R)— or —C(O)N(R)R—
and is preferably —O—
Z is preferably 2 to 100, more preferably 5 to 50, most preferably 10 to 40, calculated as a molar average.

Particularly preferably R is 16-18 and Z is 20-30.

These ingredients are particularly advantageous in so called dilute at home products, in which they aid the spontaneous mixing on the concentrated product and water, when the consumer dilutes at home.

### Polyethylene Glycols:

Polyethylene glycols (PEGs) have a general formula:

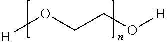

n is preferably 2 to 200, more preferably 2 to 100, even more preferably 2 to 40, 2 to 30 and most preferably 2 to 20.

The weight average molecular weight of the PEG is preferably 100 to 1000, more preferably 100 to 800, most preferably 100 to 600.

The PEG may solely comprise carbon from carbon capture or may comprise carbon from carbon capture in combination with carbon from other sources, as described above.

Materials Substituted with Polyethylene Glycols:

These are materials obtained by the reaction of PEG or ethylene oxide with another ingredient. For example, the reaction of ethylene oxide and castor oil results in a PEG hydrogenated castor oil.

Preferably these materials are hydrogenated castor oils. Preferably the castor oil is hydrogenated with 10 to 80 moles of ethylene oxide, preferably 20 to 60 moles of ethylene oxide. A particularly preferable ingredient is PEG 40 hydrogenated castor oil.

### Percent Modern Carbon

The percentage modern carbon (pMC) level is based on measuring the level of radiocarbon (C14) which is generated in the upper atmosphere from where it diffuses, providing a general background level in the air. The level of C14, once captured (e.g. by biomass) decreases over time, in such a way that the amount of C14 is essentially depleted after 45,000 years. Hence the C14 level of fossil-based carbons, as used in the conventional petrochemical industry is virtually zero.

A pMC value of 100% biobased or biogenic carbon would indicate that 100% of the carbon came from plants or animal by-products (biomass) living in the natural environment (or as captured from the air) and a value of 0% would mean that all of the carbon was derived from petrochemicals, coal and other fossil sources. A value between 0-100% would indicate a mixture. The higher the value, the greater the proportion of naturally sourced components in the material, even though this may include carbon captured from the air.

The pMC level can be determined using the % Biobased Carbon Content ASTM D6866-20 Method B, using a National Institute of Standards and Technology (NIST) modern reference standard (SRM 4990C). Such measurements are known in the art are performed commercially, such as by Beta Analytic Inc. (USA). The technique to measure the C14 carbon level is known since decades and most known from carbon-dating archaeological organic findings.

The particular method used by Beta Analytic Inc., which is the preferred method to determine pMC includes the following:

Radiocarbon dating is performed by Accelerator Mass Spectrometry (AMS). The AMS measurement is done on graphite produced by hydrogen reduction of the CO₂ sample over a cobalt catalyst. The CO₂ is obtained from the combustion of the sample at 800° C.+ under a 100% oxygen atmosphere. The CO₂ is first dried with methanol/dry ice then collected in liquid nitrogen for the subsequent graphitization reaction. The identical reaction is performed on reference standards, internal QA samples, and backgrounds to ensure systematic chemistry. The pMC result is obtained by measuring sample C14/C13 relative to the C14/C13 in Oxalic Acid II (NIST-4990C) in one of Beta Analytic's multiple in-house particle accelerators using SNICS ion source. Quality assurance samples are measured along with the unknowns and reported separately in a “QA report”. The radiocarbon dating lab requires results for the QA samples to fall within expectations of the known values prior to accepting and reporting the results for any given sample. The AMS result is corrected for total fractionation using machine graphite d13C. The d13C reported for the sample is obtained by different ways depending upon the sample material. Solid organics are sub-sampled and converted to CO₂ with an elemental analyzer (EA). Water and carbonates are acidified in a gas bench to produce CO₂. Both the EA and the gas bench are connected directly to an isotope-ratio mass spectrometer (IRMS). The IRMS performs the separation and measurement of the CO₂ masses and calculation of the sample d13C.

In one embodiment, the ingredient comprising at least one ethoxylate unit and at least one carbon derived from carbon capture comprises carbons from point source carbon capture. These ingredients preferably have a pMC of 0 to 10%.

In an alternate embodiment, the ingredient comprising at least one ethoxylate unit and at least one carbon derived from carbon capture comprises carbons from direct air capture. These ingredients preferably have a pMC of 90 to 100%.

### Perfume

The compositions of the present invention comprise perfume i.e. free oil perfume or non-confined perfumes. The compositions my preferably also comprise perfume microcapsules.

The compositions of the present invention may comprise one or more perfume compositions. The perfume compositions may be in the form of a mixture of free perfume compositions or a mixture of encapsulated and free oil perfume compositions.

Preferably the compositions of the present invention comprise 0.5 to 20 wt. % perfume ingredients, more preferably 1 to 15 wt. % perfume ingredients, most preferably 2 to 10 wt. % perfume ingredients. By perfume ingredients it is meant the combined free perfume and any encapsulated perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20 wt. %, more preferably 0.1 to 15 wt. %, more preferably from 0.1 to 10 wt. %, even more preferably from 0.1 to 6.0 wt. %, most preferably from 0.5 to 6.0 wt. %, based on the total weight of the composition.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components are as described for free perfumes.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the composition.

### Anionic and Cationic Surfactants

The compositions of the present invention are not a traditional laundry detergent or fabric conditioning compositions. The compositions of the present invention preferably comprise low levels or most preferably no anionic or cationic surfactant.

The laundry serum compositions of the present invention preferably comprises less than 4 wt. % anionic and/or cationic surfactant, more preferably less than 2 wt. % anionic and/or cationic surfactant, even more preferably less than 1 wt. % anionic and cationic surfactant, even more preferably less than 0.85 wt. % anionic and cationic surfactant and most preferably less than 0.5 wt. % anionic and cationic surfactant. The composition can be completely free of anionic and cationic surfactants.

In other words, the compositions preferably comprise 0 to 4 wt. % anionic and/or cationic surfactant, preferably 0 to 2 wt. % anionic and/or cationic surfactant, more preferably, 0 to 1 wt. % anionic and/or cationic surfactant, even more preferably 0 to 0.85 wt. % and most preferably 0 to 0.5 wt. % anionic and/or cationic surfactant. The composition can be completely free of anionic and cationic surfactant.

### Rheology Modifier

The laundry serum compositions preferably comprise a rheology modifier. Rheology modifiers are particularly preferred in compositions comprising microcapsules. Rheology modifiers may be inorganic or organic, polymeric or non polymeric. Non-limiting examples of suitable rheology modifiers include: pectine, alginate, arabinogalactan, carageenan, gellan gum, polysaccharides such as xanthum gum, guar gum, acrylates/acrylic polymers, water-swellable clays, fumed silicas, acrylate/aminoacrylate copolymers, salts and mixtures thereof.

Preferred rheology modifier for compositions comprising microcapsules herein include those selected from the group consisting of acrylate/acrylic polymers, gellan gum, fumed silicas, acrylate/aminoacrylate copolymers, water-swellable clays, polysaccharides such as xanthum gum and mixtures thereof. Most preferably the rheology modifier is selected from polysaccharides such as xanthum gum, acrylate/acrylic polymers, acrylate/aminoacrylate copolymers, and water-swellable clays. Most preferred rheology modifier are polysaccharides such as xanthum gum.

When present, a rheology modifier is preferably present in an amount of 0.001 to 10 wt. % percent, preferably from 0.005 to 5 wt. %, more preferably 0.01 to 3 wt. % of the composition.

### Other Ingredients

The laundry serums described herein preferably comprise at least 50 wt. % water, preferably 65 wt. %, more preferably 80 wt. % water and most preferably at least 90 wt. % water. the compositions may comprise less than 99 wt. % water, preferably less than 95 wt. % water. Other liquid carriers may be used, for example solvents such as propylene glycol or low molecular weight polyethylene glycols.

The compositions of the present invention may contain further optional laundry ingredients. Such ingredients include clourants, preservatives, pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials and antifungals, thickeners, low levels of cationic surfactants such as quaternary ammonium compounds and skin benefit agents.

### Form of Composition

The viscosity of the laundry serum composition is preferably 30 to 15000 mPa·s, more preferably 50 to 1000 mPa·s, most preferably 80 to 800 mPa·s. This viscosity provides the benefit that a laundry liquid can carry the serum composition into the laundry process. The viscosity measurement can be carried out at 25° C., using a 4 cm diameter 2° cone and plate geometry on a DHR-2 rheometer ex. TA instruments. In detail, the measurement can be conducted using a TA-Instruments DHR-2 rheometer with a 4 cm diameter 2 degree angle cone and plate measuring system. The lower Peltier plate is used to control the temperature of the measurement to 25° C. The measurement protocol is a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

### Method of Producing the Laundry Serums

In one aspect of the present invention is provided a method of preparing a laundry serum composition, wherein the method comprises the steps of:
i. Obtaining an ingredient comprising at least one ethoxylate unit and at least one carbon derived from carbon capture;
ii. Incorporating said ingredient into a laundry serum composition.

In other words, the liquid composition as described herein may be manufactured by adding the ingredients to the liquid carrier (i.e. water) with stirring.

### Use of the Laundry Serums

In one aspect of the present invention is provided a use of a laundry serum as described herein to reduce carbon emissions into the atmosphere. This is achieved by re-using carbon which is already in the atmosphere or which will be emitted into the atmosphere (e.g. from industry) rather than using carbon from virgin fossil fuels. The laundry serums as described herein can contribute to slowing the rate of carbon entering the atmosphere. In other words carbon derived from carbon capture can be used in a laundry serum to reduce carbon emissions in the atmosphere. This is achieved by re-using carbon which has been or will be emitted into the atmosphere rather than using virgin petrochemicals.

Additionally, the use of an ingredient comprising at least one ethoxylate unit and at least one carbon derived from carbon capture provides the consumer with a tangible eco marker in the product. Accordingly, in one aspect of the present invention is provided a use of an ingredient comprising at least one ethoxylate unit and at least one carbon derived from carbon capture as a tangible eco marker in a laundry serum composition. The tangible eco marks the change in carbon providence for the consumer. This may be a change in the smell of the product. In other words carbon derived from carbon capture may be used to change the fragrance of a laundry serum, thereby providing the consumer with a tangible marker and a reason to believe.

The ancillary laundry composition may be added to the laundry process in either the wash or the rinse phase of the laundry process. Preferably the ancillary laundry composition is added during the rinse phase of the laundry process.

The compositions comprise less than 4 wt. % cationic and/or anionic surfactant (i.e. 0 to 2 wt. %). Therefore, the ancillary composition alone does not deliver any detersive action, nor does it deliver fabric softening cationic surfactants. The compositions are intended for use in combination with traditional laundry liquids (detergent or fabric conditioner) or powder.

### EXAMPLES

The following ingredients are illustrative of ingredient comprising at least one ethoxylate unit and at least one carbon derived from carbon capture.

TABLE 1
Alcohol ethoxylate

| | Ethoxylate (25EO) | Alkyl (C16/18) |
|---|---|---|
| Comparative A | Virgin fossil fuel | Virgin fossil fuel |
| Example 1 | Virgin fossil fuel | Carbon Capture |
| Example 2 | Carbon Capture | Palm oil |
| Example 3 | Carbon Capture | Carbon Capture |

TABLE 2
Polyethylene glycol (molecular weight 200)

| | Ethylene oxide |
|---|---|
| Comparative B | 100% Virgin fossil fuel |
| Example 4 | 30% Virgin fossil fuel, 70% carbon |
| | capture |
| Example 5 | 50% bioethanol, 50% carbon capture |
| Example 6 | 100% Carbon Capture |

The following compositions are laundry serum compositions according to the present invention:

TABLE 3
Laundry serum

wt. % active

| | Example 7 | Example 8 |
|---|---|---|
| Alcohol ethoxylate - Example 3 | 4 | — |
| PEG - Example 4 | — | 6 |
| Free perfume | 10 | 8 |
| Encapsulated perfume | — | 2 |
| Rheology modifier ¹ | — | 0.2 |
| Water | To 100 | To 100 |

Rheology modifier ¹ - xanthan gum

### Product Assessment

TABLE 4
Compositions

wt. % inclusion

| Ingredient | A | 1 |
|---|---|---|
| Nonionic surfactant¹ | 1.2 | — |
| Nonionic surfactant² | — | 1.2 |
| Xanthan gum | 2 | 2 |
| Fragrance oil | 3 | 3 |
| Perfume microcapsule | 3 | 3 |
| Minors | <1 | <1 |
| Water | To 100 | To 100 |

Nonionic surfactant¹ - Cetostryl Alcohol ethoxylate with 25EO (EO groups derived from petrochemicals)
Nonionic surfactant² - Cetostryl Alcohol ethoxylate with 25EO (EO groups derived from carbon capture)

The compositions were prepared by the following method. The xanthan gum was dispersed in cold water. The dispersed xanthan was then mixed with water at a temperature of ˜60° C. The nonionic surfactant was heated to ˜65° C. and the fragrance oil mixed in. This premix was added to the water and xanthan mix. The perfume microcapsules were finally added with stirring.

A fragrance assessment was carried out on both compositions. Both compositions comprised the same amount of the same perfume, however it was identified composition 1 smelt ‘fresher’.

The compositions were then used in a laundry cycle and the damp fabrics assessed. It was assessed that the aldehydic note was more pronounced from the fabrics treated with composition 1 than composition A.

The inclusion of a non-ionic surfactant comprising at least one ethoxylate unit and at least one carbon derived from carbon capture led to a different product smell, which marks a difference between the products for the consumers.

1. A laundry serum composition compromising:
a. ingredient comprising at least one ethoxylate unit and at least one carbon derived from carbon capture;
b. free perfume;
c. 0 to 4 wt. % anionic and/or cationic surfactant.

2. The laundry serum according to claim 1, wherein the composition comprises 0.1 to 5 wt. % ingredient comprising at least one ethoxylate unit and at least one carbon derived from carbon capture.

3. The laundry serum according to claim 1, wherein the composition comprises at least 50 wt. % water.

4. The laundry serum according to claim 1, wherein at least 50 wt. % of carbon atoms in ingredient a) are obtained from carbon capture.

5. The laundry serum according to claim 1, wherein less than 90 wt. %, of carbon atoms in ingredient a) are obtained directly from virgin fossil fuel sources.

6. The laundry serum according to claim 1, wherein the carbon derived from carbon capture forms part of an alkyl chain or an ethoxylate group.

7. The laundry serum according to claim 1, wherein ingredient a) is selected from alcohol ethoxylates, polyethylene glycols and materials substituted with polyethylene glycols.

8. The laundry serum according to claim 1, wherein all carbons within the ingredient a) are derived from carbon capture or a combination of carbon capture and plant source.

9. The laundry serum according to claim 1, wherein the carbon obtained from carbon capture is obtain form point source carbon capture.

10. The laundry serum according to claim 1, wherein the composition comprises perfume microcapsules.

11. The laundry serum according to claim 1, wherein the composition comprises a rheology modifier.

12. A method of preparing the laundry serum composition according to claim 1, wherein the method comprises the steps of:
i. obtaining an ingredient comprising at least one ethoxylate unit and at least one carbon derived from carbon capture;
ii. incorporating said ingredient into a composition to produce the laundry serum composition; and
iii. recovering the laundry serum composiiton.

13. The method of preparing a laundry serum composition according to claim 12 wherein the method further comprises the step of adding a colorant, preservative, antibacterial agent, antifungal agent, antistatic agent or a mixture thereof.
